(19) United States
(12) Patent Application Publication
(10) Pub. No.: US 2007/0083713 A1
(43) Pub. Date: Apr. 12, 2007

(54) System on a chip integrated circuit, processing system and methods for use therewith

(76) Inventors: Antonio Torrini, Austin, TX (US); Robert Koelling, Austin, TX (US); Romesh Mangho Jessani, Austin, TX (US); David Baker, Austin, TX (US)

Correspondence Address: GARLICK HARRISON & MARKISON, P.O. BOX 160727, AUSTIN, TX, 78716-0727, US

(21) Appl. No.: 11/247,740

(22) Filed: Oct. 11, 2005

(51) Int. Cl. G06F 12/00

(52) U.S. Cl. 711/125

(57) ABSTRACT

A method of executing a program using a processor is implemented by executing a first main program segment stored in a ROM device until a first ROM instruction address, corresponding to one of a first sequence of ROM instructions, matches one of a plurality of a patch addresses stored in a patch register set. In response to this matching, a first patch program segment, stored in a RAM device, is executed.

### CROSS REFERENCE TO RELATED PATENTS

Not applicable

### BACKGROUND OF THE INVENTION

1. Technical Field of the Invention

The present invention relates to processing systems as may be used in system on a chip integrated circuits and related methods.

2. Description of Related Art

As is known, integrated circuits are used in a wide variety of electronic equipment, including portable, or handheld, devices. Such handheld devices include personal digital assistants (PDA), CD players, MP3 players, DVD players, AM/FM radio, a pager, cellular telephones, computer memory extension (commonly referred to as a thumb drive), etc. Each of these handheld devices includes one or more integrated circuits to provide the functionality of the device. As an example, a handheld FM radio receiver may include multiple integrated circuits to support the reception and processing of broadcast radio signals in order to produce an audio output that is delivered to the user through speakers, headphones or the like. Many such integrated circuits include a processing device that executes a program that includes a sequence of instructions that are stored in a memory device.

FIG. 1 presents a schematic block diagram representation of a prior art processing system 150. In particular, the processing system 150 is presented for executing a main program 112. Processing system 150 includes a processor 100 that is coupled to read only memory (ROM) device 102, random access memory (RAM) device 104, and flash memory device 106 via bus 108. As implemented in the prior art, a boot loader 110 is stored in ROM device 102. When the processing system 150 is booted, the boot loader 110 is executed by processor 100. Boot loader 110 includes operational instructions that cause the processor to retrieve the main program 112 stored in flash memory device 106, and to copy the main program 112 to the RAM device 104 (the copy being shown as main program 112′). The boot loader 110 further includes an instruction to jump to the main program 112′ stored in the RAM device 104 to begin execution of the main program 112′.

One problem with the processing system 150 is that, because the main program 112 requires many more instructions that boot loader 110, this configuration requires much more storage capacity for RAM device 104 than for ROM device 102. This is undesirable from a cost perspective, because a RAM device can cost much more than a ROM device with comparable storage capacity.

FIG. 2 presents a schematic block diagram representation of an alternative prior art processing system 160. In particular, processing system 160 attempts to solve the problem associated with processing system 150, by storing the main program 112 directly on ROM device 102. This configuration lowers the cost of implementation compared with processing system 150, however, a further problem is created. In the event that code changes are required or “bugs” are discovered in main program 112 after the ROM device 102 has been burned and installed, correction of these bugs requires replacement of the entire processing system 160. As one of ordinary skill in the art will understand, this device replacement adds additional cost to the support of processing system 160.

The need exists for a processing system that can be implemented in a cost effective manner, particularly for use in system on a chip integrated circuits and in handheld electronic devices.

### BRIEF DESCRIPTION OF THE SEVERAL VIEWS OF THE DRAWINGS

FIG. 1 presents a combination schematic/block diagram representation of a prior art processing system 150;

FIG. 2 presents a schematic block diagram representation of an alternative prior art processing system 160;

FIG. 3 presents a combination schematic/block diagram representation of a processing system in accordance with an embodiment of the present invention;

FIG. 4 presents a pictorial representation of a ROM device and RAM device in accordance with an embodiment of the present invention;

FIG. 5 presents a flowchart representation of a method in accordance with an embodiment of the present invention;

FIG. 6 presents a flowchart representation of a method in accordance with a further embodiment of the present invention;

FIGS. 7-9 present pictorial views of a table, registers and patch code section in accordance with an embodiment of the present invention;

FIG. 10 presents a flowchart representation of a boot loader routine in accordance with an embodiment of the present invention;

FIG. 11 presents a schematic block diagram of a handheld audio system in accordance with an embodiment of the present invention; and

FIG. 12 presents a pictorial representation of a universal service bus (USB) device in accordance with an embodiment of the present invention.

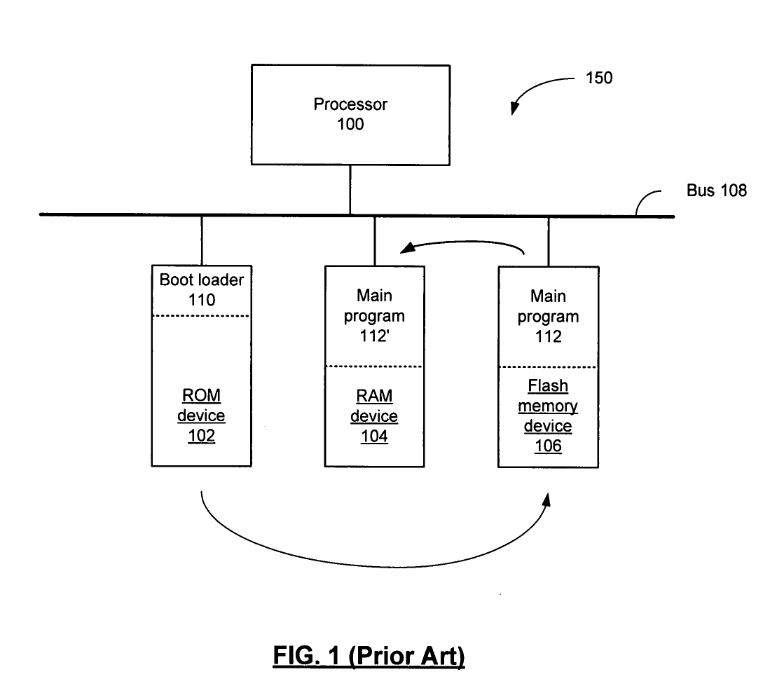

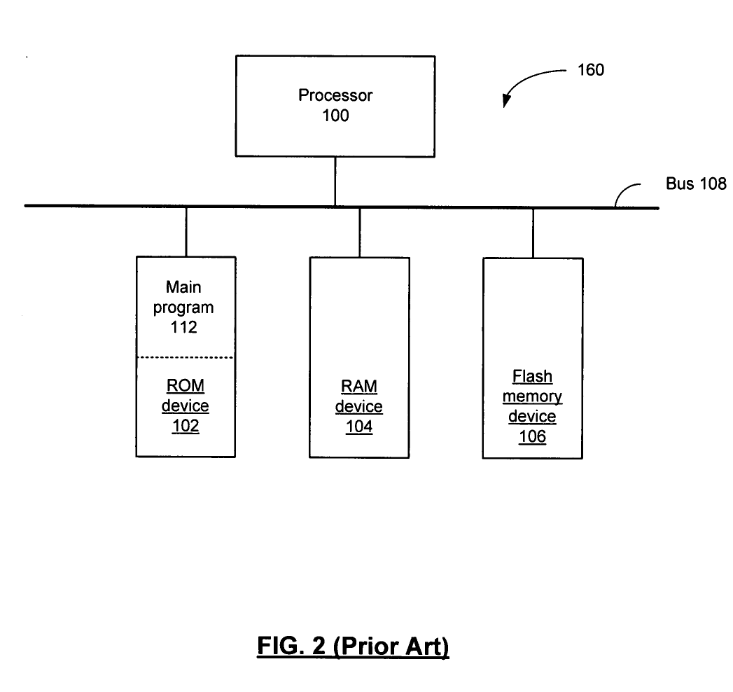

### DETAILED DESCRIPTION OF THE INVENTION INCLUDING THE PRESENTLY PREFERRED EMBODIMENTS

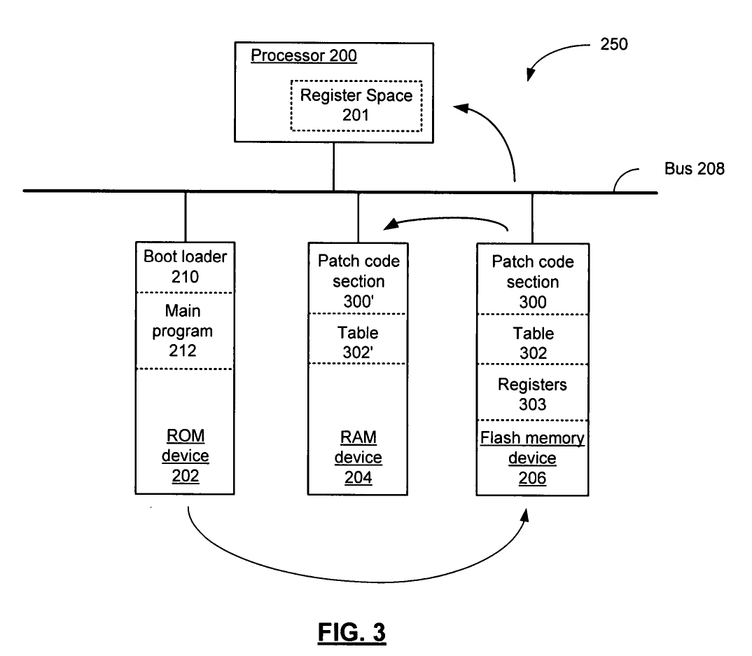

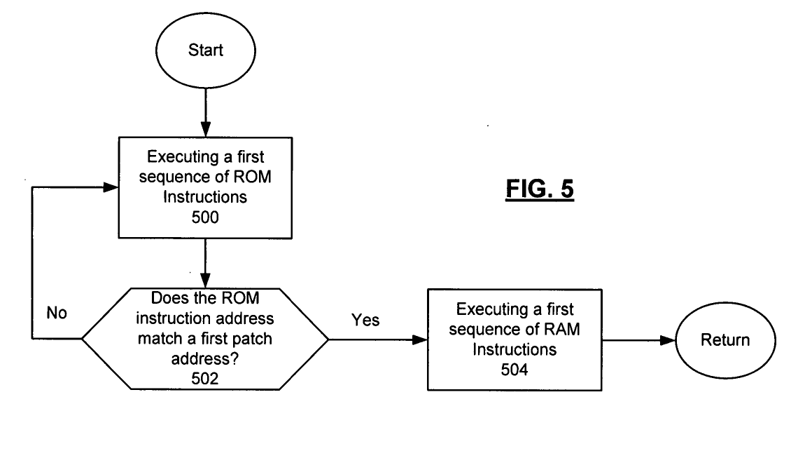

FIG. 3 presents a combination schematic/block diagram representation of a processing system in accordance with an embodiment of the present invention. In particular, a processing system 250 is presented for executing a main program 212. Processing system 250 includes a processor 200 that has a dedicated register space 201 for storing a plurality of registers such a general purpose registers and special purpose registers. Processor 200 is coupled to read only memory (ROM) device 202, random access memory (RAM) device 204, and flash memory device 206 via bus 208. A boot loader 210 and main program 212 are stored in ROM device 202. Patch code section 300, table 302 and registers 303 are stored in flash memory device 206. Patch code section 300 includes one or more patch code segments that are written to replace corresponding sections of main program 212 that require code changes. Table 302 includes a limited amount of other instructions and/or data associated with the patch code segments as will be described in further detail in conjunction with FIG. 5.

When the processing system 250 is booted, the boot loader 210 is executed by processor 200 to retrieve the patch code section 300, table 302 and registers 303 from flash memory device 206, and to copy the patch code section 300 and table 302 to the RAM device 204 (the copies being shown as patch code section 300′ and table 302′) and registers 303 to register space 201. The boot loader 210 further includes an instruction to jump to the main program 212 stored in the ROM device 202 to begin execution of the main program 212. In operation, the processor 200 executes the main program 212 stored in ROM device 202, but jumps to replacement segments of patch code from patch code section 300′ stored in RAM device 204.

In processing system 250, RAM device 204 can be implemented with less storage capacity, as compared with the prior art processing system 150 because it only needs to hold the patch code segments (that replace those limited segments of main program 212 that require code changes) and the associated instructions and data in table 302′ as opposed to the main program. Unlike prior art processing system 160, software updates and revisions can be loaded and stored in flash memory 206 as patch code segments without requiring the replacement of ROM device 202. Further, this prevents expensive tapeouts by using software fixes to override hardware bugs/erratas.

Further functions and features of the invention will be discussed in the Figures that follow.

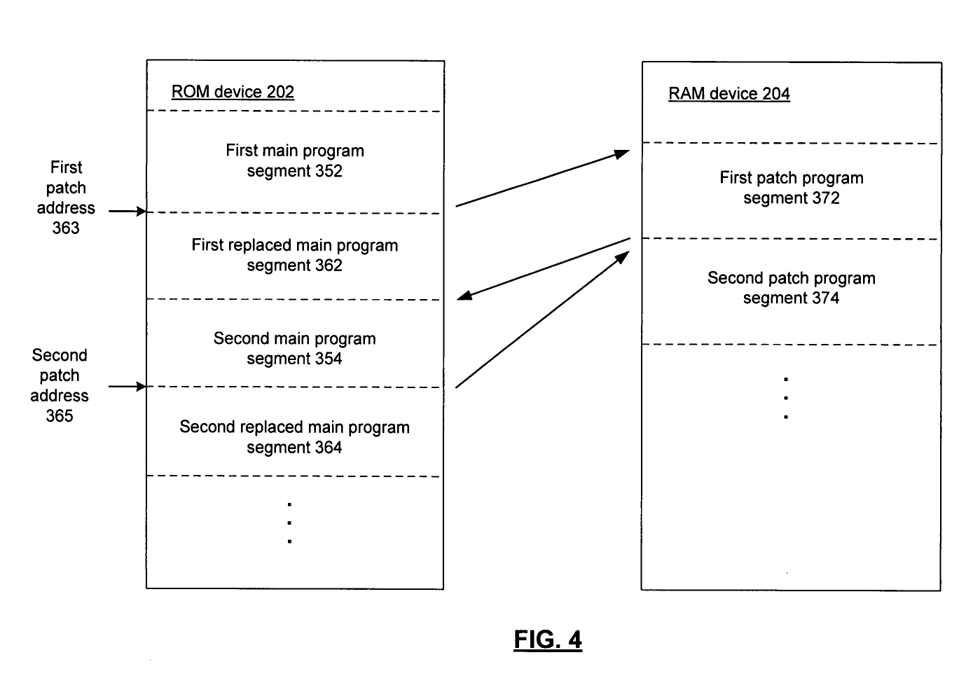

FIG. 4 presents a pictorial representation of a ROM device and RAM device in accordance with an embodiment of the present invention. In particular, FIG. 4 shows an example of the flow of execution of a program between main program segments stored in ROM device 202 and patch program segments stored in RAM device 204. The program may be an operating system program, application or other program (e.g., MP3 and/or WMA digital audio playback, file transfer, MPEG, video playback, JPEP display, audio, video and/or still image recording, etc.), series of programs, or subroutines that comprises one or more operating instructions for a processor, such as processor 200.

ROM device 202 includes a main program, such as main program 212, that is broken up into a first main program segment 352 and a second main program segment 354, that are portions of the original code from main program 212 considered to be error free. The main program further includes a first replaced main program segment 362 and a second replaced main program segment 364 that have been replaced, respectively, by first patch program segment 372 and second patch program segment 374 that are stored in RAM device 204. While FIG. 4 presents an embodiment of the present invention whereby two patch program segments replace two corresponding main program segments, one of ordinary skill in the art, when presented with present disclosure, will recognize that an arbitrary number of program segments may likewise be replaced.

The first and second main program segments 352 and 354, and the first and second replaced main program segments 362 and 364 are each made up of a sequence of operation instructions that are stored in ROM device 202. In an embodiment of the present invention, these operational instructions are stored in a contiguous block with sequential addresses in the ROM device 202. The beginning of first replaced code section 362 is recorded by storing the address of the first instruction as first patch address 363 in a patch register set. Similarly, the beginning of second replaced code section 364 is recorded by storing the address of the first instruction as second patch address 365 in a patch register set. In an embodiment of the present invention, patch register set is stored as part of table 302.

In operation, the processor, such as processor 200, executes a revised or corrected version of main program 212 by executing the unreplaced main program segments from ROM device 202 and a series of patch program segments from RAM device 204. The processor begins the execution of the program, by executing a first sequence of ROM instructions of first main program segment 352. The execution of the program continues until execution of the first main program segment 352 reaches a ROM instruction address that matches one of a plurality of a patch addresses stored in a patch register set. In the example shown in FIG. 4, the execution of the first main program segment ends when the ROM instruction address matches one of the patch addresses stored in the patch register set, in this instance the first patch address 363. In response to the first ROM instruction address matching the first patch address 363, the execution of the program shifts by executing the first patch program segment 372.

After the processor has completed the sequence of RAM instructions that make up the first patch program segment 372, the execution of the program continues by the processor returning to a second main program segment 354. In an embodiment of the present invention, the final instruction of first patch program segment 372 includes a jump command that is operative to jump to the initial address of second main program segment 354. Execution of the second main program segment 354 continues until the ROM instruction address matches a second matching patch address of the plurality of patch addresses stored in the patch register set, in this case, the second patch address 365. In response to the ROM instruction address matching the second patch address 365, the execution of the program shifts to the RAM device 204 by executing the second patch program segment 374.

While the embodiment shown above begins by executing a first main program segment 352 stored in ROM device 202, if the first segment was replaced, the execution of the program could likewise begin with first patch program stored in RAM device. In this circumstance, order of execution of the first main program segment 352 and first replaced main program segment 362 would be reversed, and similarly, the order of execution of second main program segment 354 and second replaced main program segment 364 would be reversed, from the ordering shown in FIG. 4.

It should be noted that the numerals 352, 354, 362, 364, 365, 372 and 374 are reference numerals for the elements described herein. The memory addresses associated with these elements may be either physical memory addresses or mapped virtual addresses, as will be under stood by one of ordinary skill in the art when presented the disclosure herein.

FIG. 5 presents a flowchart representation of a method in accordance with an embodiment of the present invention. In particular, the embodiment presented in conjunction with FIG. 5 may be implemented in accordance with other embodiments to implement patch code segments that implement updates or revisions to the main program that potentially add or remove features or functionality in the main program, in addition to replacing code that includes errors or bugs. In this embodiment, a first sequence of RAM instructions, such as first program segment 372, implements the various revisions and updates, features and functionality. Alternatively, a feature or function that is removed, such as first replaced main program segment 362, is replaced by a first sequence of RAM instructions that operate to jump to the next main program segment.

The method begins in step 500 by executing a first sequence of ROM instructions stored in a ROM device, such as ROM device 202. In step 502, the method continues by determining if a ROM instruction address, corresponding to one of the first sequence of ROM instructions, matches one of a plurality of a patch addresses stored in a patch register set. If the ROM instruction address matches a first matching patch address of the plurality of patch addresses stored in a patch register set, the method proceeds to step 504 by executing a first sequence of RAM instructions stored in a RAM device, such as RAM device 204. Otherwise, the execution of the first sequence of ROM instructions continues in step 500.

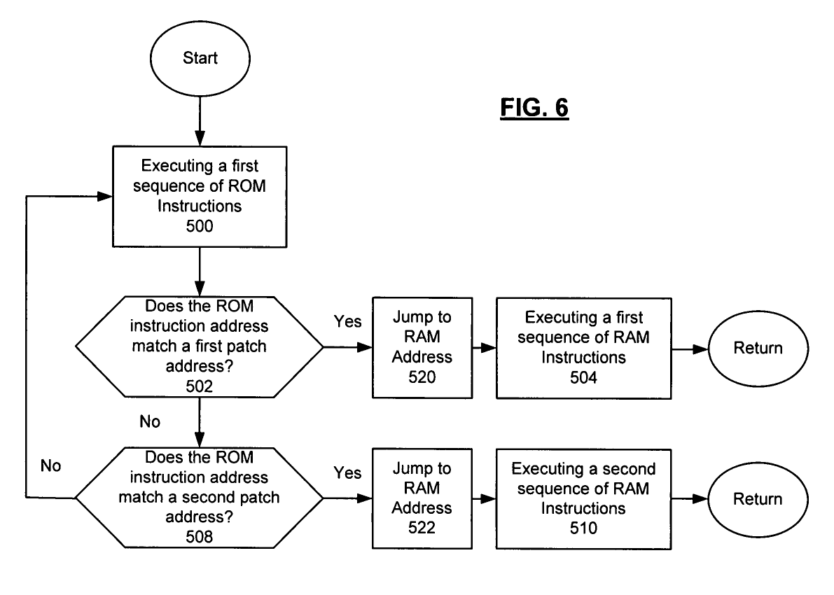

FIG. 6 presents a flowchart representation of a method in accordance with a further embodiment of the present invention. In this embodiment, in addition to determining if a ROM instruction address, corresponding to one of the first sequence of ROM instructions, matches one of a plurality of a patch addresses stored in a patch register set, the method further determines if a ROM instruction address, corresponding to one of the first sequence of ROM instructions, matches a second of a plurality of a patch addresses stored in a patch register set. While two such comparisons are shown for two such patch addresses and two corresponding sequences of RAM instructions, an arbitrary number of comparisons can likewise be implemented as will be evident to one skilled in the art based on the disclosure presented herein.

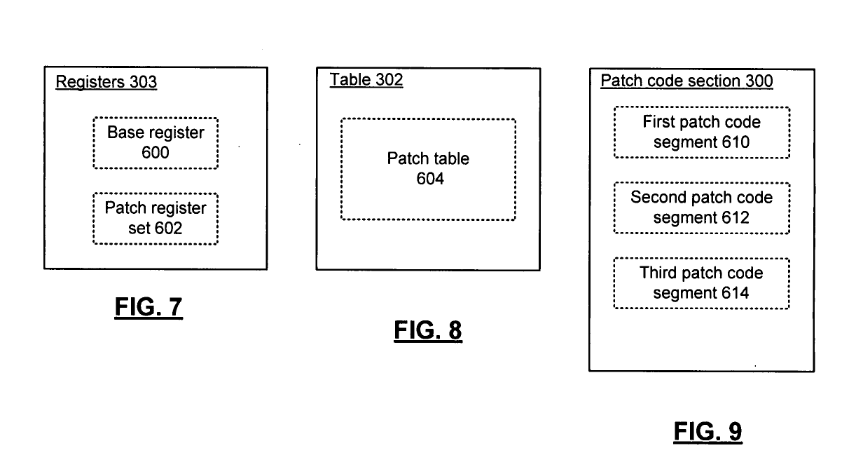

In addition, the method includes step 520 for jumping to the RAM address that corresponds to the first instruction of the first sequence of RAM instructions and step 522 for jumping to the RAM address that corresponds to the first instruction of the second sequence of RAM instructions. The calculation of these RAM addresses facilitates the transition of the program execution from ROM instructions to RAM instructions as previously described. Further details surrounding these calculations will be presented in conjunction with FIGS. 7-9.

FIGS. 7-9 present pictorial views of a table, registers and patch code section in accordance with an embodiment of the present invention. In particular, an embodiment of table 302 and patch code section 300 are shown. In this embodiment, registers 303 include a base register 600, and patch register 602. Table 302 includes patch table 604. Patch code section 300 includes a plurality of patch code segments including, for instance, first patch code segment 610, second patch code segment 612 and third patch code segment 614.

The base code register 600 stores a base address that corresponds to the RAM address of the top of the patch table 604. Patch register set 602 stores a plurality of patch addresses, such as first and second patch addresses 363 and 365, corresponding to the addresses in ROM for a plurality of replaced main code program segments. A tabular representation of an example patch register set 602 is presented below:

| Index | Patch Address |
|---|---|
| 0 | First patch address |
| 1 | Second patch address |
| . | . |
| . | . |
| . | . |

In accordance with an embodiment of the present invention, the patch table 604 is stored in RAM device 204 at an initial address that corresponds to the base address stored in the base register 600. A tabular representation of an example patch table 604 is presented below:

| Address | Command/Operand |
|---|---|
| Base address | Jump |
| Base address + 1 | Address of first patch code segment 610 |
| Base address + 2 | default |
| Base address + 3 | default |
| Base address + 4 | Jump |
| Base address + 5 | Address of second patch code segment 612 |
| Base address + 6 | default |
| Base address + 7 | default |
| . | . |
| . | . |
| . | . |

In operation, the RAM address for the first instruction of a patch program segment is calculated as follows. The base address is retrieved from the base register 600. An initial address index is calculated based on an index of the matching patch address as follows:
Initial index address=base address+4(index of matching patch address)
The initial index address that is calculated in this fashion is used as the address of the command/operand from the patch table 604 to initiate the jump command to begin execution of a corresponding patch code segment. For example, if the current ROM address matched the second patch address, the index of 1 from patch register set 602 is used in the calculation above to generate an initial index address as follows:
Initial index address=base address+4(1)=base address+4
The command and operand beginning at this address in patch table 604 are fetched and executed by the processor 200 to jump to the address of the second patch code section 612. While a particular method for calculating the initial address of a patch code section is described above, other methods of retrieving an initial address that may or may not use a base register or patch table as described herein can likewise be implemented within the broad scope of the present invention. In an alternative embodiment of the present invention, the initial address of a patch code section can be stored in the patch code register in direct association with the corresponding patch address, such as when the register length is sufficient to hold two addresses, or in alternative configurations such as where patch address and the initial address of its corresponding patch code segment are stored in successive indices in the patch register.

In a preferred embodiment of the patch table 604 shown above, four addresses are reserved for each patch address in patch register set 602. While a command and operand to jump to a corresponding patch code segment requires only two of the four addresses (with the second two addresses storing arbitrary default values), very short corrections can be implemented within the patch table itself—for instance, in the event that a replaced main code segment consists of a single incorrect command or operand. This avoids the double branching that occurs in the embodiment described above whereby the first patch program segment is implemented by a first set of RAM instructions stored contiguously in a patch table of the RAM device (such as a jump command described above) and a second set of RAM instructions stored contiguously in a patch code section of the RAM device (the execution of the corresponding patch code segment). In this case, the patch table 604 command/operands would conclude with a jump command and address the cause the processor 200 to begin execution of the next main program segment. While the description above discusses a patch table that includes four addresses reserved for each patch address, a greater number of addresses could be reserved to implement longer patch code segments directly from the patch table. Similarly, fewer addresses can be reserved if the double branching described above is implemented in association with each patch code segment. Further embodiments to implement the jump from a replaced ROM instruction to a replacement patch code section are likewise possible, as will be apparent to one skilled in the art when presented the disclosure herein.

While the embodiments described above utilize jump commands to transfer execution of the program from ROM device 202 to the patch table 604, and then (optionally) to a corresponding patch code segment of the patch code section 300 and back to the next main program segment stored in ROM device 202, other branching, go to, jumping, jump to subroutine, or subroutine calls can likewise be implemented as will be understood by one of ordinary skill in the art when presented with the disclosures of the present invention. In accordance with a further embodiment of the present invention, the patch register set 602 includes, for each index, a flag that indicates whether or not the corresponding patch program segment replaces an interrupt service routine (ISR). In this event, the presence of the ISR flag for a particular index can be used to implement a jump to subroutine command to begin execution of the corresponding contents of patch table 604, rather than a jump command, for processors that will not allow an ISR to begin with a jump command.

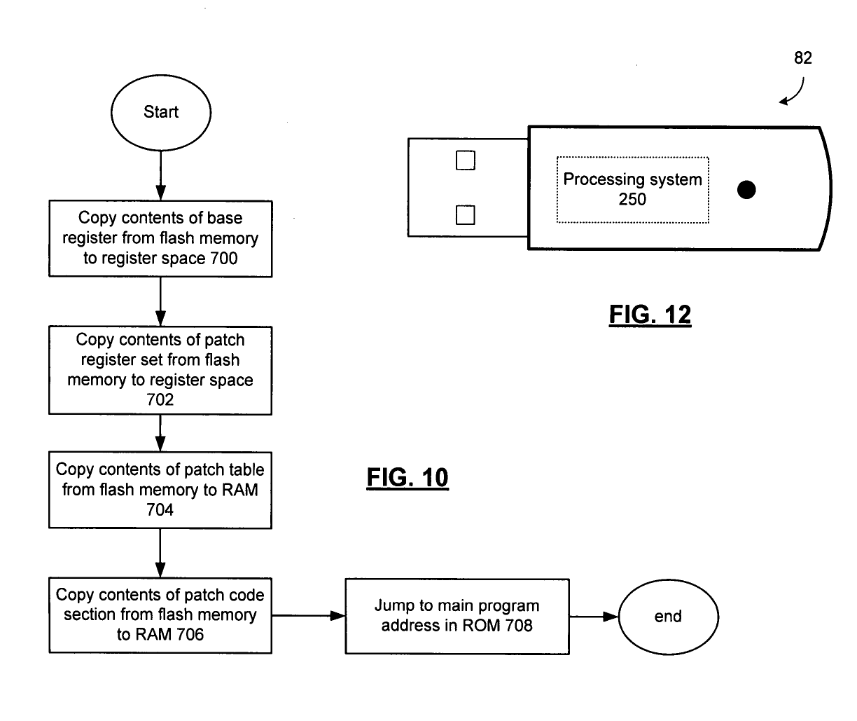

FIG. 10 presents a flowchart representation of a boot loader routine in accordance with an embodiment of the present invention. The method begins in step 700 by copying the contents of the base register 600 from a flash memory device 206 to the register space, such as register space 201. In step 702, the contents of the patch register set 602 are copied from the flash memory device 206 to register space, such as register space 201. In step 704, the contents of the patch table 604 are copied from the flash memory device 206 to the RAM device 204. In step 706, the contents of the patch code section 300 are copied from the flash memory device 206 to the RAM device 204. In step 708, the execution of the program begins by jumping to the address of the first instruction of the first main program segment such as main program section 352 described in conjunction with FIG. 4.

While the term “copying” is used above, this term includes the use of processor block copy commands, retrieve and store commands, and other program commands that depend upon the processor and implementation, as will be understood by one of ordinary skill in the art when presented the disclosure of the present invention.

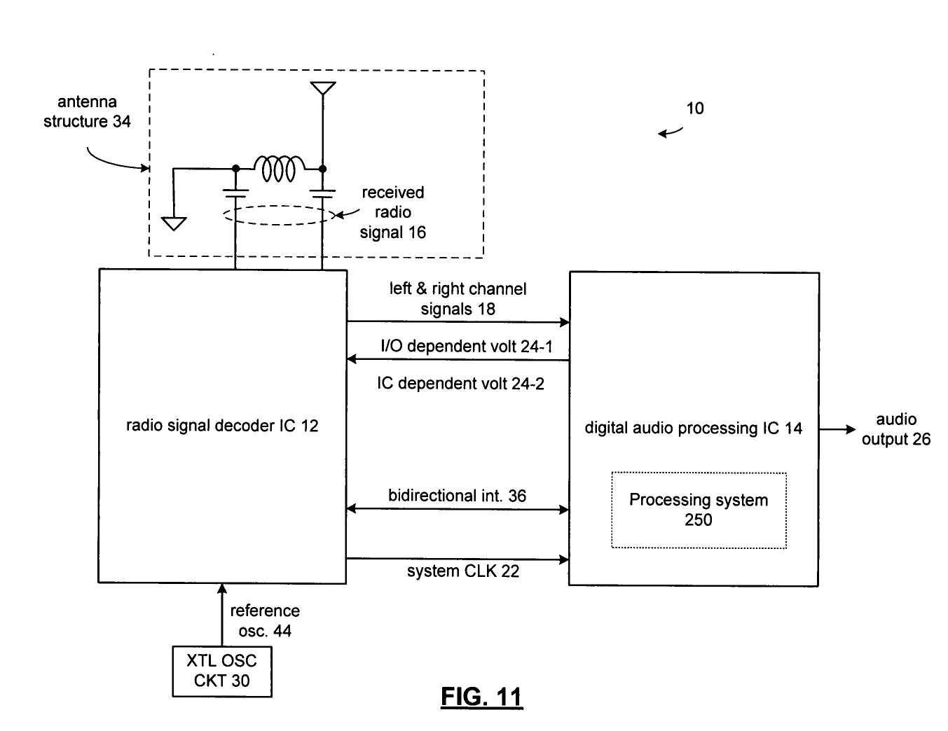

FIG. 11 presents a schematic block diagram of a handheld audio system in accordance with an embodiment of the present invention. In particular, a schematic block diagram of a handheld audio system 10 is presented that includes a radio signal decoder integrated circuit 12 and a digital audio processing integrated circuit 14. The digital audio processing integrated circuit 14 includes memory, and a DC-to-DC converter. The digital audio processing integrated circuit 14 is an example of a system on a chip integrated circuit that includes a processing system 250 as described in conjunction with FIGS. 3-10.

In this embodiment, the radio signal decoder integrated circuit 12 is operably coupled to a crystal oscillator circuit 30 and an antenna structure 34. The crystal oscillation circuit 30 is operably coupled to a crystal and produces therefrom a reference oscillation 44. The antenna structure 34 includes an antenna, a plurality of capacitors and an inductor coupled as shown. The received radio signal 16, which may be an AM radio signal, FM radio signal, satellite radio signal, cable radio signal, is provided from the antenna structure 34 to the radio signal decoder integrated circuit 12.

The radio signal decoder integrated circuit 12 includes a radio stage 102 that performs the function of radio signal decoding. Radio stage 102 converts the received radio signal 16, into left and right channel signals 18 (i.e., a digital stereo signal), which may include a Left+Right signal and a Left−Right signal. The radio signal decoding IC 12 provides the left and right channel signals 18 to the digital audio processing IC 14. Note that the left and right channel signals 18 may be digital signals or analog signals.

The digital audio processing integrated circuit 14 includes an audio output stage 106 that receives the left and right channel signals 18 and produces therefrom audio signals 26. The digital audio processing IC 14 may provide the audio signals 26 to a headphone set or other type of speaker output. As an alternative to producing the audio signals 26 from the left and right channel signals 18, the digital audio processing integrated circuit 14 process stored MP3 files, stored WMA files, and/or other stored digital audio files to produce the audio signals 26.

In an embodiment of the present invention, the digital audio processing integrated circuit 14, via a DC-DC converter, generates an input/output (I/O) dependent supply voltage 24-1 and an integrated circuit (IC) dependent voltage 24-2 that are supplied to the radio signal decoder IC 12. In one embodiment, the I/O dependent voltage 24-1 is dependent on the supply voltage required for input/output interfacing of the radio signal decoder IC and/or the digital audio processing IC 14 (e.g., 3.3 volts) and the IC dependent voltage 24-2 is dependent on the IC process technology used to produce integrated circuits 12 and 14. In alternative embodiments, other structures and methods for supplying power to and from integrated circuits 12 and 14 may be employed within the broad scope of the present invention.

The interface between the integrated circuits 12 and 14 further includes a bi-directional interface 36. Such an interface may be a serial interface for the integrated circuits 12 and 14 to exchange control data and/or other type of data. In one embodiment, the bi-directional interface 36 may be one or more serial communication paths that are in accordance with the I²C serial transmission protocol. As one or ordinary skill in the art will appreciate, other serial transmission protocols may be used for the bi-directional interface 36 and the bi-directional interface 36 may include one or more serial transmission paths.

FIG. 12 presents a pictorial representation of a universal service bus (USB) device in accordance with an embodiment of the present invention. In particular, USB device 82 includes processing system 250 as has been described in conjunction with the various embodiments of the present invention. In particular, USB device and processing system 250 can be implemented in a configuration that includes one or more system on a chip integrated circuits. In an embodiment of the present invention USB device 82 includes a mass storage drive for providing portable storage capacity to a computer or other USB compatible device. In an alternative embodiment, USB 82 includes an infrared communications device for communicating between a USB compatible device and other electronic devices via an infrared communications link. While FIGS. 11 and 12 present two possible implementations of the method, processing system and system on a chip integrated circuits of the present invention, other applications and implementations are likewise possible in other electronic devices, handheld or otherwise, as will be apparent to one skilled in the art when presented the disclosure herein.

The various processors disclosed herein can be implemented using a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. Further note that, the memory stores, and the processing module executes, operational instructions corresponding to at least some of the steps and/or functions illustrated herein.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

In preferred embodiments, the various circuit components are implemented using 0.08 to 0.35 micron CMOS technology. Provided however that other circuit technologies, both integrated or non-integrated, may be used within the broad scope of the present invention. Likewise, various embodiments described herein can also be implemented as software programs running on a computer processor. It should also be noted that the software implementations of the present invention can be stored on a tangible storage medium such as a magnetic or optical disk, read-only memory or random access memory and also be produced as an article of manufacture.

Thus, there has been described herein an apparatus and method, as well as several embodiments including a preferred embodiment, for implementing a system on a chip integrated circuit and processing system. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A method of executing a program using a processor, the method comprising the steps of:
executing a first main program segment that includes a first sequence of read only memory (ROM) instructions stored in a ROM device until a first ROM instruction address that corresponds to one of the first sequence of ROM instructions correlates with a first matching patch address of a plurality of a patch addresses stored in a patch register set; and
in response to the first ROM instruction address correlating with the first matching patch address, executing a first patch program segment stored in a random access memory (RAM) device.

2. The method of claim 1 further comprising the step of:
returning to a second main program segment that includes a second sequence of ROM instructions stored in the ROM device upon completion of the first patch program segment.

3. The method of claim 2 further comprising the step of:
in response to a second ROM instruction address, corresponding to one of the second sequence of ROM instructions, matching a second matching patch address of the plurality of patch addresses stored in the patch register set, executing a second patch program segment stored in the RAM device.

4. The method of claim 1 further comprising the step of:
calculating a RAM address for a first instruction of the first patch program segment.

5. The method of claim 4 wherein the step of calculating a RAM address for the first instruction of the patch program segment includes:
retrieving a base address from a base register; and
calculating an initial address index based on an index of the first matching patch address.

6. The method of claim 5 further comprising the steps of:
copying contents of the base register from a flash memory device to a register space.

7. The method of claim 1 further comprising the steps of:
copying contents of the patch register set from a flash memory device to a register space.

8. The method of claim 1 wherein the first patch program segment includes a first set of RAM instructions stored contiguously in a patch table of the RAM device and a second set of RAM instructions stored contiguously in a patch code section of the RAM device.

9. The method of claim 8 further comprising the steps of:
copying contents of the patch table from a flash memory device to the RAM device; and
copying contents of the patch code section from the flash memory device to the RAM device.

10. The method of claim 1 wherein the program includes at least one of: an application program, and an operating system.

11. A processing system comprising:
a read only memory (ROM) device for storing a first sequence of ROM instructions;
a random access memory (RAM) device for storing a first sequence of RAM instructions and a patch register set; and
a processor, operably coupled to the ROM device and the RAM device, the processor, operable to:
execute the first sequence of ROM instructions until a first ROM instruction address, corresponding to one of the first sequence of ROM instructions, matches one of a plurality of a patch addresses stored in the patch register set; and
in response to the first ROM instruction address matching a first matching patch address of the plurality of patch addresses stored in the patch register set, execute the first sequence of RAM instructions.

12. The processing system of claim 11 wherein the processor is further operable to:
return to the first sequence of ROM instructions upon completion of the first sequence of RAM instructions.

13. The processing system of claim 11 wherein the processor is further operable to:
in response to a second ROM instruction address, corresponding to one of the first sequence of ROM instructions, matching a second matching patch address of the plurality of patch addresses stored in a patch register set, execute a second sequence of RAM instructions stored in the RAM device.

14. The processing system of claim 11 wherein the processor is further operable to:
calculate a RAM address for the first instruction in the first sequence of RAM instructions.

15. The processing system of claim 14 wherein the processor is further operable to calculate a RAM address for a first instruction in the first sequence of RAM instructions by:
retrieving a base address from a base register; and
calculating an initial address index based on an index of the first matching patch address.

16. The processing system of claim 15 further comprising:
a flash memory device, operably coupled to the processor.

17. The processing system of claim 16 wherein the ROM device further stores a boot loader.

18. The processing system of claim 17 wherein the boot loader includes instructions that cause the processor to:
copy contents of the base register from the flash memory device to a register space;
copy contents of the patch register set from the flash memory device to the register space;
copy contents of the patch table from the flash memory device to the RAM device; and
copy contents of the patch code section from the flash memory device to the RAM device.

19. A system on a chip integrated circuit for use in a multi-function handheld device, the system on a chip integrated circuit comprising:
a ROM device for storing a first sequence of ROM instructions;
a RAM device for storing a first sequence of RAM instructions and a patch register set; and
a processor, operably coupled to the ROM device and the RAM device, the processor, operable to:
execute the first sequence of ROM instructions until a first ROM instruction address, corresponding to one of the first sequence of ROM instructions, matches one of a plurality of a patch addresses stored in the patch register set; and
in response to the first ROM instruction address matching a first matching patch address of the plurality of patch addresses stored in a patch register set, execute the first sequence of RAM instructions.

20. The system on a chip integrated circuit of claim 19 wherein the processor is further operable to:
return to the first sequence of ROM instructions upon completion of the first sequence of RAM instructions.

21. The system on a chip integrated circuit of claim 19 wherein the processor is further operable to:
in response to a second ROM instruction address, corresponding to one of the first sequence of ROM instructions, matching a second matching patch address of the plurality of patch addresses stored in a patch register set, execute a second sequence of RAM instructions stored in the RAM device.

22. The system on a chip integrated circuit of claim 19 wherein the processor is further operable to:
calculate a RAM address for a first instruction in the first sequence of RAM instructions.

23. The system on a chip integrated circuit of claim 19 wherein the processor is further operable to calculate a RAM address for the first instruction in the first sequence of RAM instructions by:
retrieving a base address from a base register; and
calculating an initial address index based on an index of the first matching patch address.

24. The system on a chip integrated circuit of claim 23 further comprising:
a flash memory device, operably coupled to the processor.

25. The system on a chip integrated circuit claim 24 wherein the ROM device further stores a boot loader.

26. The system on a chip integrated circuit of claim 25 wherein the boot loader includes instructions that cause the processor to:
copy contents of the base register from the flash memory device to a register space;
copy contents of the patch register set from the flash memory device to the register space;
copy contents of the patch table from the flash memory device to the RAM device; and
copy contents of the patch code section from the flash memory device to the RAM device.

27. A method of executing a program using a processor, the method comprising the steps of:
executing read only memory (ROM) instructions of a non-boot program stored in a ROM device until a ROM instruction address that corresponds to one of the ROM instructions correlates with a patch address stored in a patch register set; and
in response to the ROM instruction address correlating with the patch address, executing random access memory (RAM) patch instructions stored in a RAM device.

28. The method of claim 27 further comprising the step of:
returning to the first sequence of ROM instructions upon completion of the first sequence of RAM instructions.

29. The method of claim 27 further comprising the step of:
in response to a second ROM instruction address, corresponding to one of the first sequence of ROM instructions, matching a second matching patch address of the plurality of patch addresses stored in a patch register set, executing a second sequence of RAM instructions stored in the RAM device.

30. The method of claim 27 further comprising the step of:
calculating a RAM address for a first instruction in the first sequence of RAM instructions.

31. The method of claim 30 wherein the step of calculating a RAM address for the first instruction in the first sequence of RAM instructions includes:
retrieving a base address from a base register; and
calculating an initial address index based on an index of the first matching patch address.

32. The method of claim 31 further comprising the steps of:
copying contents of the base register from a flash memory device to a register space.

33. The method of claim 27 further comprising the steps of:
copying contents of the patch register set from a flash memory device to a register space.

34. The method of claim 27 wherein the first sequence of RAM instructions includes a first set of RAM instructions stored contiguously in a patch table of the RAM device and a second set of RAM instructions stored contiguously in a patch code section of the RAM device.

35. The method of claim 34 further comprising the steps of:
copying contents of the patch table from a flash memory device to the RAM device; and
copying contents of the patch code section from the flash memory device to the RAM device.

36. The method of claim 27 wherein the program includes at least one of: an application program, and an operating system.
